(19) United States
(12) Patent Application Publication
(10) Pub. No.: US 2015/0348202 A1
(43) Pub. Date: Dec. 3, 2015

(54) Insurance Claim Outlier Detection with Kernel Density Estimation

(71) Applicant: FAIR ISAAC CORPORATION, San Jose, CA (US)

(72) Inventors: Jeremy M. Greene, San Marcos, CA (US); Daniel Cociorva, San Diego, CA (US); Snehal S. Katre, San Diego, CA (US)

(73) Assignee: FAIR ISAAC CORPORATION, San Jose, CA (US)

(21) Appl. No.: 14/289,972

(22) Filed: May 29, 2014

(51) Int. Cl. G06Q 40/08; G06Q 50/18

(52) U.S. Cl. CPC G06Q 40/08; G06Q 50/18

(57) ABSTRACT

Data is received that comprises a data set characterizing a plurality of insurance claims. Thereafter, a density function of the data set is estimated using kernel density estimation. At least one claim having at least one outlier variable is then identified using the density function. Data is then provided (e.g., displayed, stored, loaded into memory, transmitted to a remote computing system, etc.) that characterizes the at least one identified claim as likely being fraudulent or erroneous. Related apparatus, systems, techniques and articles are also described.

### TECHNICAL FIELD

The subject matter described herein relates to the detection of outliers in connection with insurance claims by using kernel density estimation.

### BACKGROUND

Unsupervised outlier detection techniques have been applied to a variety of problems including insurance claim processing to identify fraud, waste, and abuse in connection with claims. For example, z-scores can be used to detect abnormal billing patterns for medical procedure codes (also known as “service codes”) by the rendering providers. This simple, univariate analysis determines outliers based on the z-scores of the payment distribution for each service code. Norms are set for each service code by calculating the average amount and standard deviation, which are stored in tabular form. Every time a rendering provider performs a certain procedure, a z-score is calculated using the amount on the claim line and the values in the norms table.

The basic assumption in this z-score approach is that the payment structures follow a normal distribution. However, it has been observed that certain characteristics such as contractual rate differences, patient population with certain diagnoses, or other insurance plan specifics, can cause the data to be bimodal, multimodal, or unstructured.

The violation of normality poses several problems for z-scores. For example, a peak towards the right tail of the distribution may get flagged as a set of outliers, thus creating false positives. This peak could just be a deviating segment of the data set with valid payments or fee schedules. In addition, the average and standard deviation for sparsely populated service codes is often sensitive and can be heavily influenced by one or few outliers. This arrangement makes for less robust z-scores. Lastly, multiple modes and lack of structure in the distribution can cause high standard deviations which, in turn, can lead to lowered z-scores causing false negatives.

### SUMMARY

In one aspect, data is received that comprises a data set characterizing a plurality of insurance claims. Thereafter, a density function of the data set is estimated using kernel density estimation. At least one claim having at least one outlier variable is then identified using the density function. Data is then provided (e.g., displayed, stored, loaded into memory, transmitted to a remote computing system, etc.) that characterizes the at least one identified claim as likely being fraudulent or erroneous.

The estimating can include placing a kernel function at each data point in the data set, and adding or averaging the kernel functions to obtain the kernel density estimation.

The kernel density estimation f(x) can be obtained using:

$$f ( x ) = \frac{1}{n} {Σ}_{i = 1}^{n} {K}_{h} ( x - {x}_{i} ) ,$$

wherein xᵢ are data points in the data set, Kₕ(t) is a kernel function, and h is a smoothing parameter.

The kernel function can be one or more of a Gaussian function, a biweight function, a triangular function, a uniform function, and a symmetric function that integrates to one.

The kernel function can be a Gaussian function and the smoothing parameter h can be determined by:

$$h = {( \frac{4 {\hat{σ}}^{5}}{3 n} )}^{\frac{1}{5}} \approx 1.06 \hat{σ} {n}^{- 1 / 5} ,$$

where n is a number of elements in the data set and a is a standard deviation of the data.

The kernel function can be a biweight function and the smoothing parameter h can be determined by:

$$h = \sqrt{7} \cdot {( \frac{4 {\hat{σ}}^{5}}{3 n} )}^{\frac{1}{5}} ,$$

where n is a number of elements in the data set and \hat{σ} is a standard deviation of the data.

In another aspect, data is received that includes a data set characterizing a plurality of insurance claims. Thereafter, using a previously generated kernel density estimation function derived from a different data set, at least one claim having at least one outlier variable is identified. Subsequently, data is provided that characterizes the at least one identified claim as likely being fraudulent or erroneous.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current subject matter provides techniques that are more robust and more universal than z-scores. In addition to identifying aberrant payments in insurance applications, the current subject matter can be used to detect fraud or outliers in any univariate data set with an unknown distribution.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a histogram of a data set;

FIG. 2 is a diagram illustrating a kernel density estimation function as applied to the data set illustrated in FIG. 1;

FIG. 3 is a diagram illustrating a kernel density estimation function as applied to a data set;

FIG. 4 is a diagram illustrating a data sample with two deviating populations within the same service code;

FIG. 5 is a diagram illustrating a kernel density estimation function as applied to the data illustrated in FIG. 4; and

FIG. 6 is a process flow diagram illustrating Insurance Claim Outlier Detection with Kernel Density Estimation.

### DETAILED DESCRIPTION

The current subject matter is directed to a non-parametric algorithm to estimate the probability density function of one variable in order to identify the outliers in the distribution. While the current description is mainly directed to the processing and characterization of healthcare insurance claims, it will be appreciated that the current subject matter is applicable to any univariate unsupervised outlier detection problem, even when the underlying structure of the data is unknown. In particular, the current subject matter can be applied to auto insurance, property and casualty insurance, and the like.

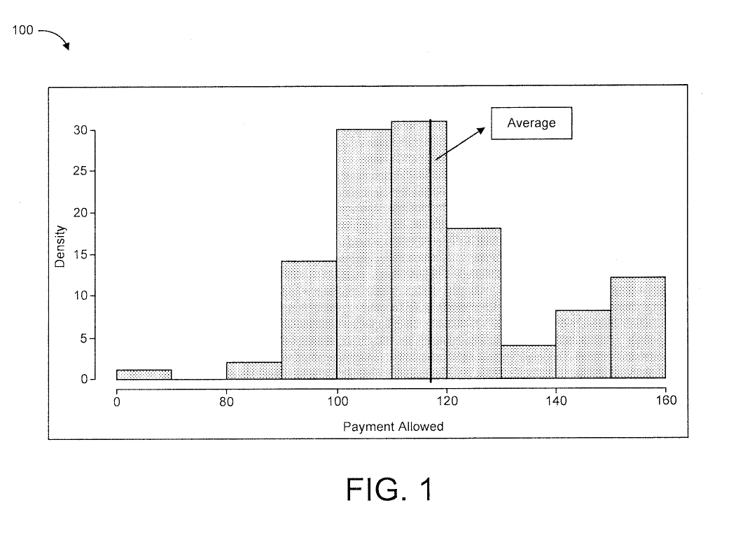

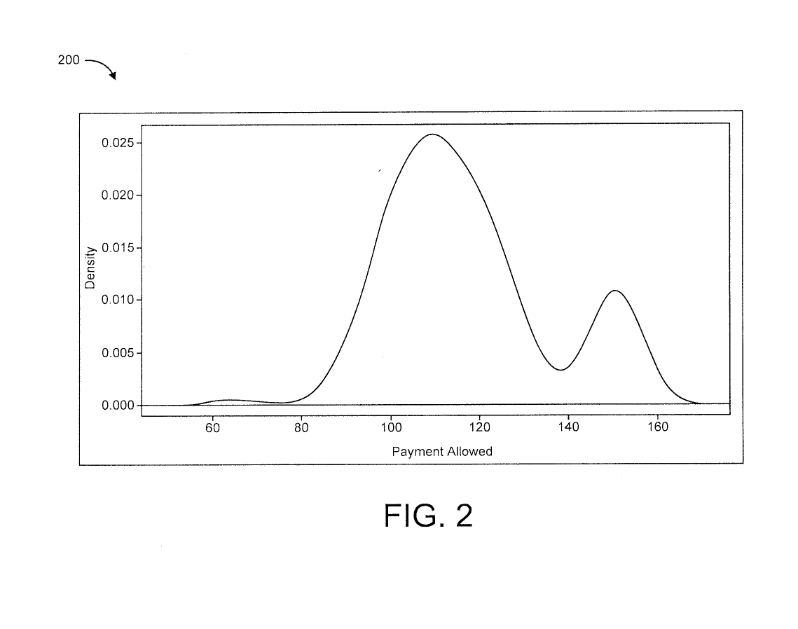

To overcome the shortcomings of conventional techniques, a kernel density estimation (KDE) technique can be used which can also be characterized as a non-parametric technique to estimate a density function of the data. The most basic form of density estimation is the histogram, where the sample space is divided into a number of bins with certain width (see diagram 100 of FIG. 1). KDE is a smoothing mechanism using the fundamentals of the histogram, with the advantage of a continuous function that does not depend on end points (see diagram 200 of FIG. 2).

With KDE, a kernel function can be placed at every data point in the distribution. Some examples of kernel functions can include Gaussian, biweight, triangular, uniform, or other symmetric function that integrates to one. Once a kernel function is placed at every data point in the distribution, the kernel functions can be added (or averaged, depending on the scaling) to obtain the final KDE using the formula

$$f ( x ) = \frac{1}{n} {Σ}_{i = 1}^{n} {K}_{h} ( x - {x}_{i} ) . \qquad ( 1 )$$

In Equation (1) above, the xᵢ are the data points in the distribution, Kₕ(t) is the kernel function, and h is a smoothing parameter called the bandwidth. There are various methods to select the optimal bandwidth. For a Gaussian kernel, the bandwidth represents the standard deviation, or width, of the kernel and it can be shown that the optimal choice for bandwidth is given by Silverman's rule of thumb:

$$h = {( \frac{4 {\hat{σ}}^{5}}{3 n} )}^{\frac{1}{5}} \approx 1.06 \hat{σ} {n}^{- 1 / 5} , \qquad ( 2 )$$

where n is the number of elements in the data set and \hat{σ} is the standard deviation of the data. Another example is if a biweight kernel is used, the optimal bandwidth is given by

h=\sqrt{7}·h_{G},

where h_{G} is the optimal bandwidth for a Gaussian kernel given by Equation (2).

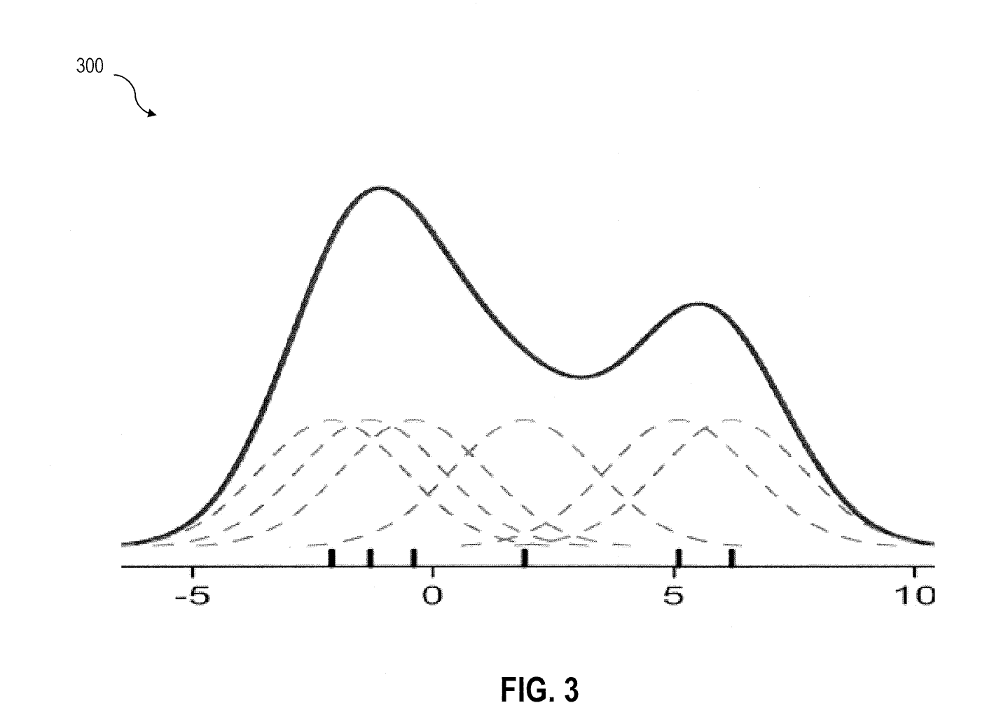

The above is illustrated in connection with diagram 300 of FIG. 3. For this figure, the data set contains the six points {−2.1, −1.3, −0.4, 1.9, 5.1, 6.2}. In FIG. 3, the dashed curves are Gaussian kernels centered at each of the six data points (with each data point as the mean and h as the standard deviation) and the solid curve is the KDE.

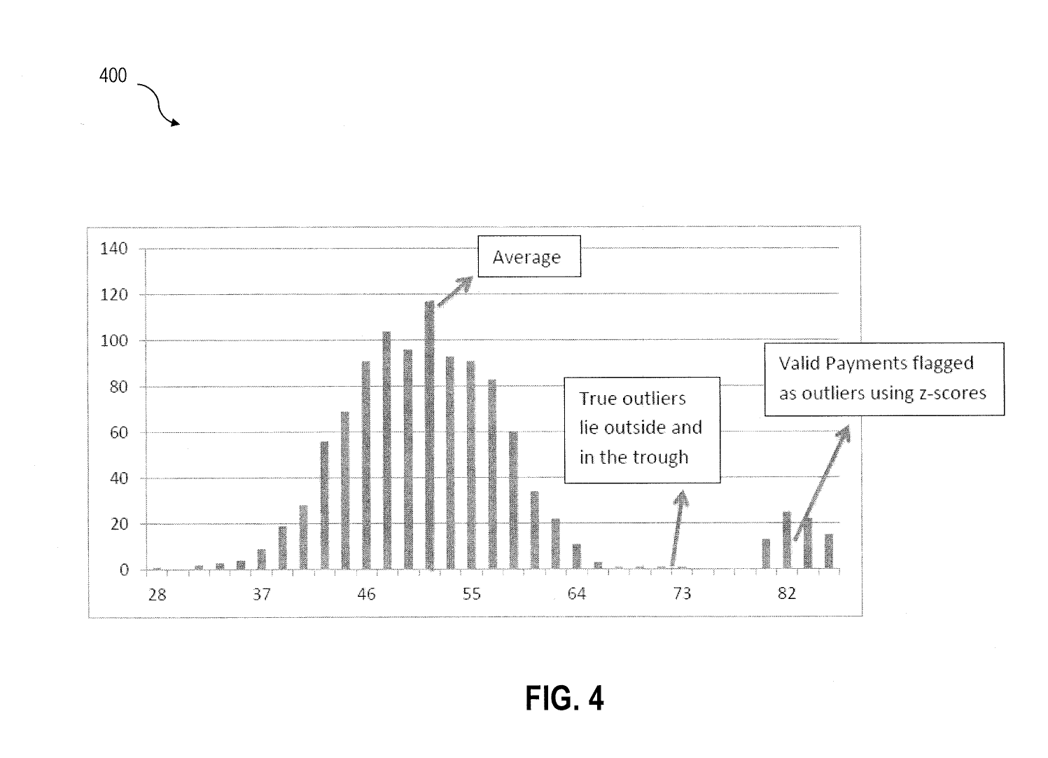

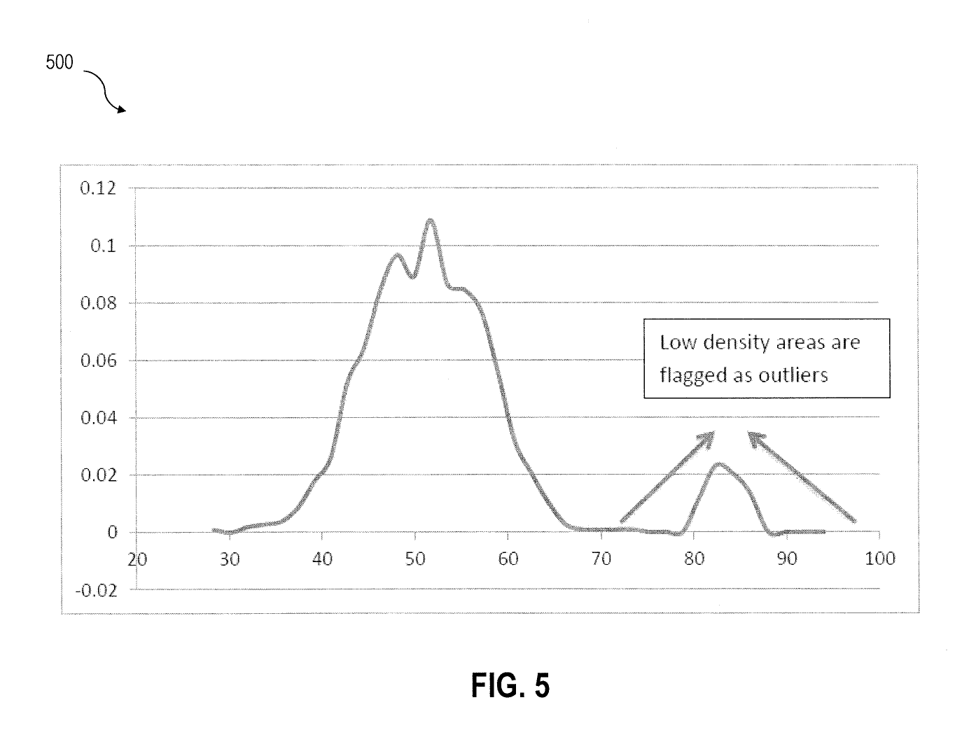

FIGS. 4 and 5 are diagrams 400, 500 that illustrate the benefits of using KDE over z-scores. FIG. 4 illustrates a data sample with two deviating populations within the same service code. The smaller population towards the right tail is flagged as outliers using z-scores. However, the true outliers fall outside of the data range, as well as in the trough between the two distinct peaks. The smoothed KDE function (see diagram 500 of FIG. 5) is not limited by the end points in the histogram.

For a given data set, KDE density values (y coordinates) can be estimated at N equally spaced data points (x coordinates) and these N pairs of (x, y) coordinates can be stored in tabular form. When a new observation is to be scored, the two nearest x values out of the N equally spaced points can be found and then linearly interpolated to obtain the proper y value of the KDE at the new observation point. This value is then scaled appropriately so it can be compared across different data sets.

For insurance claims analysis that utilize service codes, detection of outliers can be limited to low-density regions of the payment distribution of every service code. KDE eliminates false positives by identifying (and not flagging) peaks in the payment distribution of each service code.

In auto insurance fraud models and property and casualty insurance fraud models, customers are typically interested in a current snapshot of a claim. The number of variables can vary from, say, thirty to over one hundred. The variables can be at different levels such as payment, exposure, incident, policy, and insured. In building the claim profiles, some, if not all, of these individual variables with unknown distributions can now be more accurately calculated using the KDE methodology instead of z-scores, for example. For some predictive models, KDE can be used in this manner to normalize every variable prior to profile outlier detection.

KDE can also be extended from acting on single variables in a profile to acting on the multivariable profiles themselves for outlier detection. In this case, the KDE would be a multidimensional surface and finding outliers is equivalent to finding low-density regions on the surface.

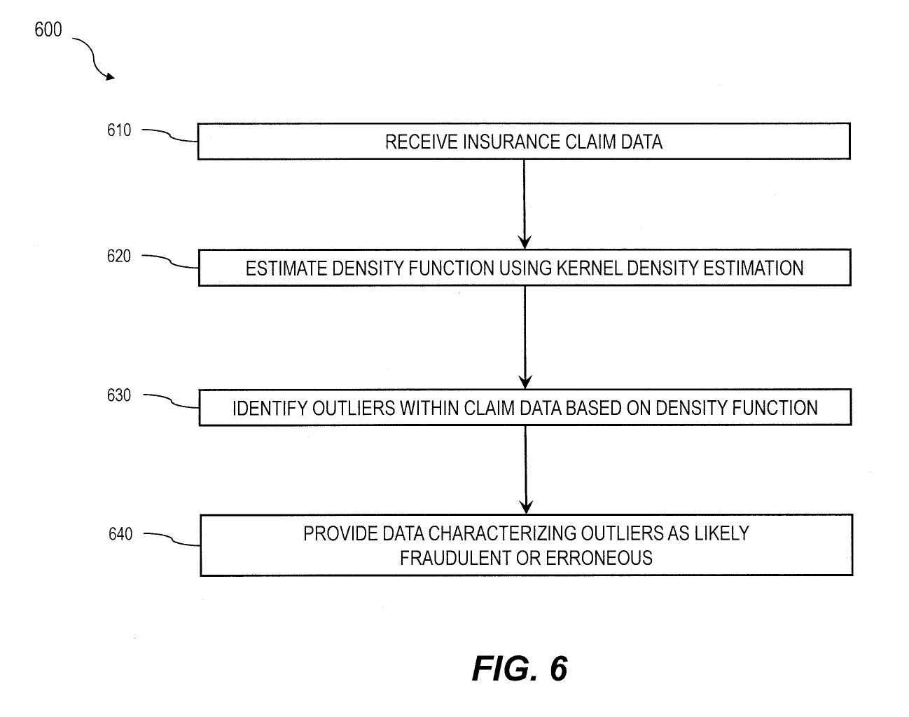

FIG. 6 is a diagram 600 illustrating a technique in which, at 610, data is received that includes a data set characterizing a plurality of insurance claims. Thereafter, at 620, a density function of the data set is estimated using kernel density estimation. The density function is then used, at 630, to identify at least one claim having at least one outlier variable. Data is then provided, at 640, that characterizes the at least one identified claim as likely being fraudulent or erroneous.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data comprising a data set characterizing a plurality of insurance claims;
estimating a density function of the data set using kernel density estimation;
identifying, using the density function, at least one claim having at least one outlier variable; and
providing data characterizing the at least one identified claim as likely being fraudulent or erroneous.

2. The method of claim 1, wherein the estimating comprises:
placing a kernel function at each data point in the data set.

3. The method of claim 2, wherein the estimating further comprises:
adding or averaging the kernel functions to obtain the kernel density estimation.

4. The method of claim 1, wherein the kernel density estimation f(x) is obtained using:
$$f ( x ) = \frac{1}{n} {Σ}_{i = 1}^{n} {K}_{h} ( x - {x}_{i} ) ,$$
wherein xᵢ are data points in the data set, Kₕ(t) is a kernel function, and h is a smoothing parameter.

5. The method of claim 4, wherein the kernel function is selected from a group consisting of: a Gaussian function, a biweight function, a triangular function, a uniform function, or a symmetric function that integrates to one.

6. The method of claim 4, wherein the kernel function is a Gaussian function and the smoothing parameter h is determined by:
$$h = {( \frac{4 {\hat{σ}}^{5}}{3 n} )}^{\frac{1}{5}} \approx 1.06 \hat{σ} {n}^{- 1 / 5} ,$$
where n is a number of elements in the data set and \hat{σ} is a standard deviation of the data.

7. The method of claim 4, wherein the kernel function is a biweight function and the smoothing parameter h is determined by:
$$h = \sqrt{7} \cdot {( \frac{4 {\hat{σ}}^{5}}{3 n} )}^{\frac{1}{5}}$$
where n is a number of elements in the data set and \hat{σ} is a standard deviation of the data.

8. The method of claim 1, wherein providing data comprises at least one of: storing at least a portion of the data characterizing the at least one identified claim as likely being fraudulent or erroneous, displaying at least a portion of the data characterizing the at least one identified claim as likely being fraudulent or erroneous, transmitting at least a portion of the data characterizing the at least one identified claim as likely being fraudulent or erroneous to a remote computing system, or loading at least a portion of the data characterizing the at least one identified claim as likely being fraudulent or erroneous into memory.

9. The method of claim 1, wherein the receiving, estimating, identifying, and providing are implemented by at least one data processor forming part of at least one computing system.

10. A non-transitory computer program product storing instructions which, when executed by at least one data processor forming part of at least one computing system, result in operations comprising:
receiving data comprising a data set characterizing a plurality of insurance claims;
estimating a density function of the data set using kernel density estimation;
identifying, using the density function, at least one claim having at least one outlier variable; and
providing data characterizing the at least one identified claim as likely being fraudulent or erroneous.

11. The computer program product of claim 10, wherein the estimating comprises:
placing a kernel function at each data point in the data set.

12. The computer program product of claim 11, wherein the estimating further comprises:
adding or averaging the kernel functions to obtain the kernel density estimation.

13. The computer program product of claim 10, wherein the kernel density estimation f(x) is obtained using:
$$f ( x ) = \frac{1}{n} {Σ}_{i = 1}^{n} {K}_{h} ( x - {x}_{i} ) ,$$
wherein xᵢ are data points in the data set, Kₕ(t) is a kernel function, and h is a smoothing parameter.

14. The computer program product of claim 13, wherein the kernel function is selected from a group consisting of: a Gaussian function, a biweight function, a triangular function, a uniform function, or a symmetric function that integrates to one.

15. The computer program product of claim 13, wherein the kernel function is a Gaussian function and the smoothing parameter h is determined by:
$$h = {( \frac{4 {\hat{σ}}^{5}}{3 n} )}^{\frac{1}{5}} \approx 1.06 \hat{σ} {n}^{- 1 / 5} ,$$
where n is a number of elements in the data set and \hat{σ} is a standard deviation of the data.

16. The computer program product of claim 13, wherein the kernel function is a biweight function and the smoothing parameter h is determined by:
$$h = \sqrt{7} \cdot {( \frac{4 {\hat{σ}}^{5}}{3 n} )}^{\frac{1}{5}}$$
where n is a number of elements in the data set and \hat{σ} is a standard deviation of the data.

17. A system comprising:
at least one data processor; and
memory storing instructions which, when executed by the at least one data processor, result in operations comprising:
receiving data comprising a data set characterizing a plurality of insurance claims;
estimating a density function of the data set using kernel density estimation;
identifying, using the density function, at least one claim having at least one outlier variable; and
providing data characterizing the at least one identified claim as likely being fraudulent or erroneous.

18. The system of claim 17, wherein the estimating comprises:
placing a kernel function at each data point in the data set; and
adding or averaging the kernel functions to obtain the kernel density estimation.

19. The system of claim 17, wherein the kernel density estimation f(x) is obtained using:
$$f ( x ) = \frac{1}{n} {Σ}_{i = 1}^{n} {K}_{h} ( x - {x}_{i} ) ,$$
wherein xᵢ are data points in the data set, Kₕ(t) is a kernel function, and h is a smoothing parameter.

20. The system of claim 17, wherein the kernel function is a Gaussian function and the smoothing parameter h is determined by:
$$h = {( \frac{4 {\hat{σ}}^{5}}{3 n} )}^{\frac{1}{5}} \approx 1.06 \hat{σ} {n}^{- 1 / 5} ,$$
where n is a number of elements in the data set and \hat{σ} is a standard deviation of the data.

21. The system of claim 17, wherein the kernel function is a biweight function and the smoothing parameter h is determined by:
$$h = \sqrt{7} \cdot {( \frac{4 {\hat{σ}}^{5}}{3 n} )}^{\frac{1}{5}}$$
where n is a number of elements in the data set and \hat{σ} is a standard deviation of the data.

22. A method comprising:
receiving data comprising a data set characterizing a plurality of insurance claims;
identifying, using a previously generated kernel density estimation function derived from a different data set, at least one claim having at least one outlier variable; and
providing data characterizing the at least one identified claim as likely being fraudulent or erroneous.
